(19) United States
(12) Patent Application Publication
(10) Pub. No.: US 2008/0222543 A1
(43) Pub. Date: Sep. 11, 2008

(54) INFORMATION TERMINAL, SERVER AND INFORMATION PROCESSING METHOD

(76) Inventors: Norihiko Naono, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/044,770

(22) Filed: Mar. 7, 2008

(30) Foreign Application Priority Data
Mar. 9, 2007 (JP) P2007-061002
May 16, 2007 (JP) P2007-131064

(51) Int. Cl. G06F 3/048; G06F 17/30

(52) U.S. Cl. 715/764; 707/10; 707/E17.107

(57) ABSTRACT

An information terminal that includes a receiver for receiving an identification tag, with the identification tag having a plurality of sets of information including first information and attribute information which is correlated with the first information, a storage device for storing the identification tag and the plurality of information sets and a display, with the display displaying the first information, and the first information being correlated with the attribute information based on the attribute information which is selected by a user from the plurality of sets of information.

### CROSS REFERENCE TO RELATED APPLICATION

This application is based upon and claims the benefit of priority from the prior Japanese Patent Application No. 2007-61002, filed on Mar. 9, 2007 and Japanese Patent Application No. 2007-131064, filed on May 16, 2007 the entire contents of which are incorporated herein by reference.

### TECHNICAL FIELD

This invention relates to an information processing method, display method, control method and database of information transferred between information terminals in multiple languages.

### DESCRIPTION OF THE RELATED ART

When managing personal information, a database for personal information such as an address list or phone book is used. In many cases, the owner of the database is required to exchange the database information with others, since it also includes a set of information about the means (contact information) used to contact others. Verbal communication such as face-to-face communication or telephonic communication, paper media exchange like business cards or exchanging information through E-mail, etc. are examples of exchanging contact information.

When exchanging contact information through the internet, some kind of standard data format should be used instead of using free formats such as E-mail, since the receiver converts the received information to a database before use. Therefore, standard formats, such as vCard standardized by the IMC (Internet Mail Consortium) is widely used. In vCard, the data format is standardized for exchanging not only basic personal information such as names, addresses, various phone numbers, e-mail addresses, Internet URL's (Universal Resource Locator), but also photos, logos, voice data and public keys. Such standard data formats have been used widely as an infrastructure for exchanging contact information through various e-mail clients, computer telephony address lists or groupware of schedule management, etc. For example, Outlook (registered trademark) of Microsoft and Lotus (registered trademark) Organizer of IBM are typical application software for exchanging personal information in vCard format.

For example, according to the vCard specifications described in Electronic Business Card Version 2.1, Versit Consortium Specification, September 18, (1996), there are 13 property parameters of phone numbers which have been defined that can be exchanged in vCard format namely; Preference number (PREF), Company (WORK), Home (HOME), Voice (VOICE), Fax (FAX), Message service (MSG), Cell number (CELL), Pager (PAGER), Bulletin board (BBS), Modem (MODEM), Car phone (CAR), ISDN (ISDN) and Videophone (VIDEO). By using this, if “TEL; PREF; WORK; CELL: 03-3456-7890” is described according to the vCard specifications, the application software on a communication partner's computer automatically identifies that the phone number is the company's cell number and it is a number used more preferentially compared to other numbers.

However, in vCard, there are 2 problems as mentioned below, when exchanging personal information in the standard data format.

The first problem is that the property parameters which are not defined in the standard data format for exchanging personal information cannot be exchanged. For example, when exchanging a phone number using vCard, since only the above-mentioned 13 property parameters are defined in vCard version 2.1, even though the Skype (registered trademark) name is sent, which is the contact destination of Skype (registered trademark) that is widely used at present as free internet telephony, the application software that receives the contact information cannot identify the property parameter of that telephone number. Similarly, the attributes of Furigana, which are widely used in Japanese language for writing names and addresses, are not defined in vCard version 2.1; therefore, Furigana cannot be exchanged through vCard. Therefore, it is not easy to formulate derived specifications of vCard according to area-wise linguistic notations, or implement standard data formats for uniform processing of various notations across the world and are not currently available.

The second problem is; even in the case where personal information of property parameters, or in more general terms, attributes, which are defined in a standard data format for exchanging personal information, is exchanged, in application software that uses the data obtained in the standard data format for exchanging personal information, there is no method for displaying the data on a Graphical User Interface (GUI) in a concise and user-friendly format. An example of a display method in the present application software is shown in FIG. 1. The example given in FIG. 1 shows the contact destination display screen of Outlook (registered trademark) of Microsoft, which is the most popular E-mail client. Here, “Ichiro Suzuki” is “Other person”, and personal information such as contact destination of “Ichiro Suzuki” disclosed to the user of this information terminal is displayed. Since, the disclosing party of personal information can select the information to be disclosed to the user of this information terminal, with respect to actual display of address list, the screen display becomes complicated with many blank fields as shown in FIG. 1. Therefore, the displayed contact information is not at all user-friendly. As in the case of Outlook (registered trademark), if the same address list application is to be used in different areas or countries, there may be some information such as a method to describe a name or address, zip code, header number in international calls and different communication means that cannot be expressed in the fields already defined by the application. For example, in countries such as Korea and Japan that use Chinese characters and country-specific characters, there is a need to include Chinese characters, country-specific characters and Alphabetic notations; however, it is not possible in the display screen of application software as shown in FIG. 1. Further, similar problems arise in a country such as India which has various languages and at least 3-4 languages are used in the same area. If address list application software compatible with several languages is to be created, the display of a GUT screen compatible with several languages will be complicated as the number of fields will increase. If any function is provided to customize the displayed screen, and if the user has a choice to select the fields to be displayed, then the complexity of the screen display will be reduced. However, there may be different languages and notations for the partners exchanging personal information. Also, if a GUT screen is simplified by customizing the displayed screen, the information of the required attributes may not be displayed.

### SUMMARY OF THE INVENTION

According to one aspect of the present invention an information terminal comprises a receiver, said receiver receiving an identification tag, said identification tag having a plurality of sets of information including first information and attribute information which is correlated with said first information, a storage device, said storage device storing said identification tag and said plurality of information sets and a display, said display displaying said first information, said first information being correlated with said attribute information based on said attribute information which is selected by a user from said plurality of sets of information.

According to one aspect of the present invention a server comprises a microprocessor, said microprocessor creating a plurality of sets of information including first information and attribute information, said attribute information is used to control displaying said first information, said microprocessor assembling said plurality of sets of information and creating an identification tag which includes assembled said plurality of sets of information, said identification tag and said plurality of sets of information being sent to an information terminal.

According to one aspect of the present invention, an information processing method comprises creating a plurality of sets of information including first information and attribute information by a microprocessor, said attribute information is used to control displaying said first information, assembling said plurality of sets of information and creating an identification tag which includes assembled said plurality of sets of information by said microprocessor, said identification tag and said plurality of sets of information being sent to an information terminal, receiving said identification tag by an information terminal, said identification tag having said plurality of sets of information including said first information and said attribute information which is correlated with said first information, storing said identification tag and said plurality of information sets in said information terminal; and displaying said first information on said information terminal, said first information being correlated with said attribute information based on said attribute information which is selected by a user from said plurality of sets of information.

### BRIEF DESCRIPTION OF THE DRAWINGS

FIG. 1 is a diagram of an address list screen according to a conventional method.

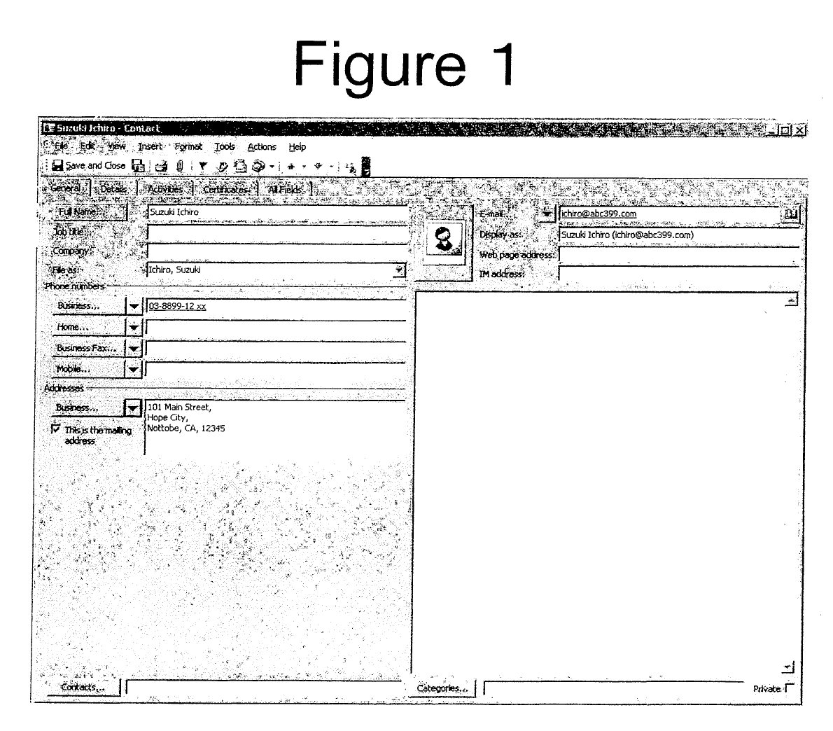

FIG. 2 is a diagram of the state where attribute information correlated with name information is received and transmitted.

FIG. 3 is a diagram of the constituent elements of an information terminal.

FIG. 4 is a diagram of embodiment 1 and a flow chart when a display attribute is specified in advance on an information terminal that receives personal information.

FIG. 5 is a diagram of embodiment 1 and a diagram of a display screen for specifying a display attribute in advance on an information terminal that receives personal information.

FIG. 6 is a diagram of embodiment 2 and a flow chart when the precedence of a display attribute is specified in advance on an information terminal that receives personal information.

FIG. 7 is a diagram of embodiment 2 and a diagram of a display screen for specifying the precedence of a display attribute in advance on an information terminal that receives personal information.

FIG. 8 is a diagram of embodiment 3 and a flow chart when attribute information correlated with personal information is selected on an information terminal that sends personal information after receiving the same.

FIG. 9 is a diagram of embodiment 3 and a diagram of a display screen to select personal information.

FIG. 10 is a diagram of embodiment 4 and a flow chart when new personal information and attribute information is associated with received personal information on a receiving information terminal

### DETAILED DESCRIPTION OF THE INVENTION

To implement the present invention, a description of the best configuration currently possible is given below. The scope of the present invention is defined clearly by that of the accompanying claims. This description should not be interpreted in a limited sense; its aim is to simply exemplify the general principle of the invention.

This invention can be used for exchanging personal information between various information terminals which are connected to a network. Any device such as personal computers, portable information terminals, fixed-line telephones, cellular phones, televisions, video recorders, cameras, video cameras, portable music players, etc. can be used as information terminals. Further, the type of information terminal of the disclosing party of the personal information and the type of information terminal of the recipient of the disclosed personal information do not have to be the same. For example, according to the method of this invention, the information disclosed through a cell phone can be received on a personal computer and it can be displayed on the display unit. Moreover, the method of this invention can be used to transfer personal information between a server and an information terminal. By using the method mentioned in this invention, in addition to personal information, information such as documents, still images, video clips, URLs (Universal Resource Locater), secret keys and public keys can also be transferred. For ease of understanding, the exchange of personal information between information terminals is explained in the example below; however, the scope of application of this invention is not restricted only to the exchange of personal information.

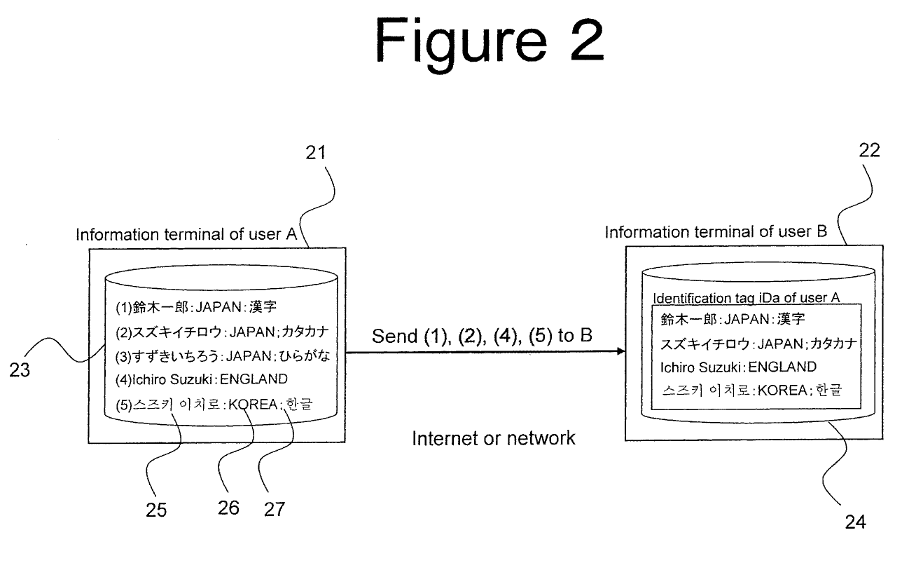

If FIG. 2 is referred, a name having 5 types of display attribute for the same person such as [symbol] [symbol] [symbol] “Ichiro Suzuki” and

[symbol]

is currently stored in memory unit 23 of information terminal 21 of User A. Moreover, the entire name information is stored by correlating it with a display attribute as in the case of vCard. For example, display attributes such as “KOREA” 26 indicating the country name and the Hangul script [symbol]
are linked with the Hangul notation 25 shown below. [symbol]
In this invention, the information to be disclosed such as 5 types of names given in the example in FIG. 2 is the name information or personal information. Further, a group of various information or personal information, and attribute information is called an information set or personal information set. Display attribute is the generic term for country name, language and notation system when displaying the name. External memory units such as Hard disk, floppy (registered trademark) disk, DVD disk and flash memory, or temporary memory unit, which are used as the main memory of an information terminal, can be used as memory unit 23 shown in FIG. 2. In the description in embodiment 1, 2, 3 and 4 given below, the name of User A is described as an example by considering it as the information to be disclosed. Any type of information such as an address, phone numbers, E-mail address, internet URL (Universal Resource Locator), photo, logo, voice data, public key or secret key can be disclosed. Embodiments 1, 2, 3 and 4 given below are explained by using the display attributes. However, these display attributes are the examples of attribute information in this invention, and the information correlated with the name information or personal information to be disclosed is not restricted to display attributes. For example, the attribute of information to be disclosed can be a name, type, contents digest or comments, etc.

The above-mentioned situations are considered in this invention. For exchanging personal information between information terminals, this invention provides a method for user-friendly display and control of the attribute information, which is not defined in the standard data format used for exchanging the personal information, or area/country-specific notations, so that the screen display will not be complicated. In this method, the screen display is flexible and can be easily managed.

### Embodiment 1

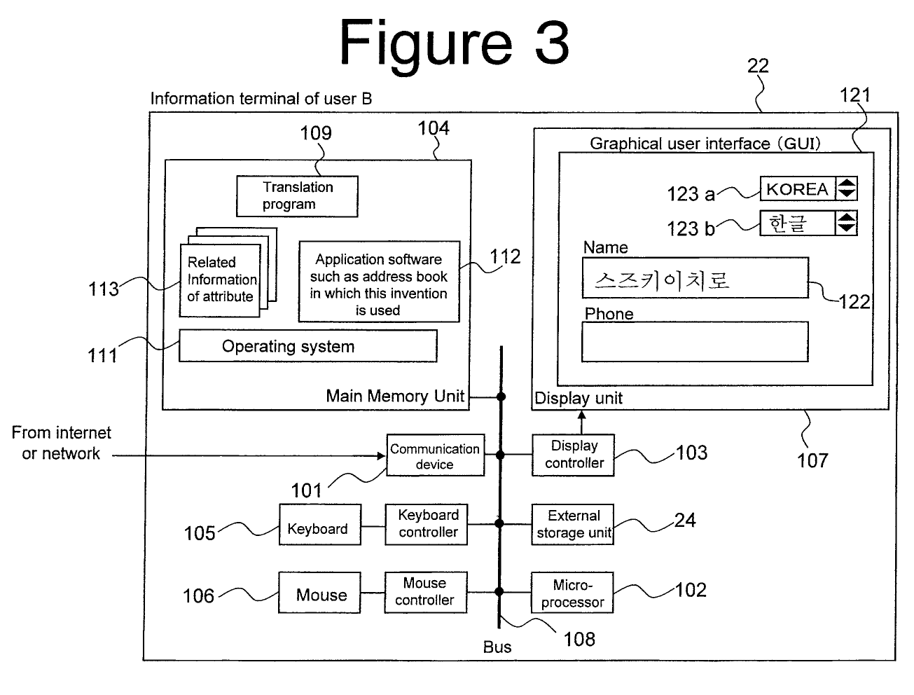

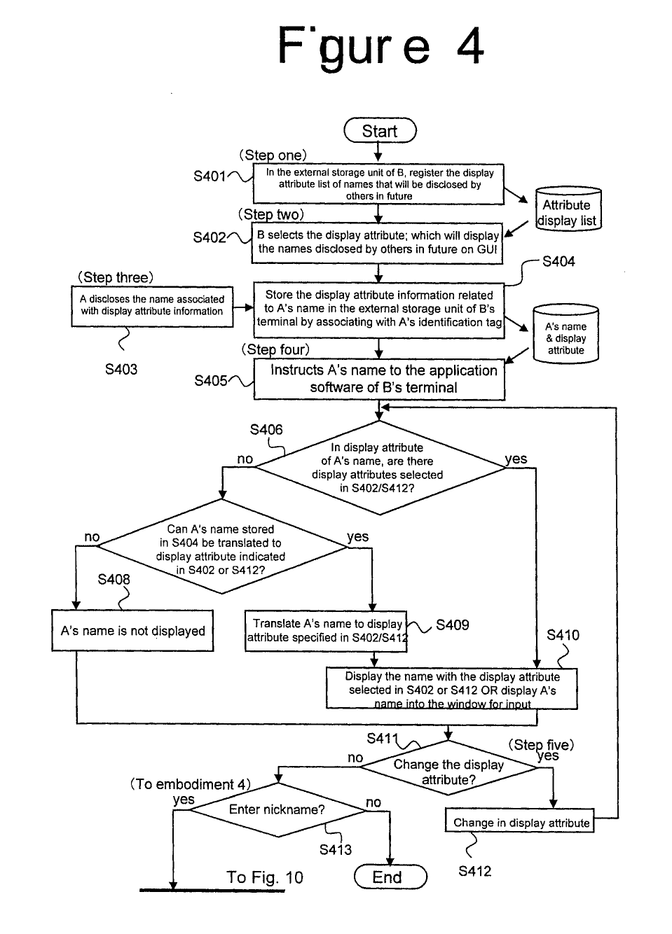

The constituent elements of information terminal 22 of User B shown in FIG. 2 are shown in FIG. 3 by using a block diagram. The following explanation is shown in FIG. 4 by using a flowchart. Referring to FIG. 3, in the first step of embodiment 1, various languages and notations are disclosed to B by A, and before sending them to terminal 22 of B, a list of display attributes that can be displayed with the name information to be disclosed by other users in future, is registered in the external memory unit 24 of FIG. 3 (Step S401). For example, display attributes such as the names of all countries, language names and names of various notation systems in various languages are stored in external memory unit 24. These display attributes may be used in the application software 112 that manages personal information such as addresses.

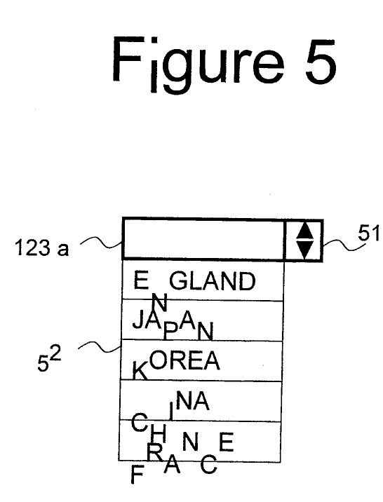

In the second step, a microprocessor 102 executes the processes according to instructions from application software 112 that manages the personal information such as an address list used in this invention. This application software 112 operates on an operating system 111, which is installed in the main memory unit (storage device) 104. As a result, a Graphical User Interface (henceforth referred to as GUI) 121 displays the information through a display controller on a display unit 107. According to the methods of this invention, a window 122 used to display or enter a name and a window 123 used for display attribute selection are provided on this GUI. There may be one or more windows on the GUI. User B uses input devices such as a keyboard 105 or a mouse 106 to operate the window 123 for display attribute selection. From the list of display attributes registered in the external memory unit 24 in the first step, User B can select the notation attributes with which the name information disclosed by other users including A, is to be displayed in window 122 (Step S402). In the example shown in FIG. 5, a window for display attribute selection, which is on GUI 121, has the options display button 51. If User B clicks this button by using mouse 106, a list of display attributes 52 is displayed, which was registered in an external memory unit in the above-mentioned first step. Further, display attributes of the names disclosed by other users can be selected by using the mouse 106. The selected display attributes are displayed in window 122 used to display or enter the names. In the example shown in FIG. 5, five languages of “ENGLAND”, “JAPAN”, “KOREA”, “CHINA” and “FRANCE” are displayed as options. If FIG. 3 is referred once again, in this example in the second step, User B selects “KOREA”, which indicates the Korean language in window 123a for display attribute selection, or selects

[symbol]

which indicates Korean characters in window 123b, in order to display the name information disclosed to User B by others, including User A, so that the information is displayed in window 122 used to display or enter the name in Korean notations.

Once again, FIG. 2 is referred to. In the third step, User A discloses all this information to User B by sending it from terminal 21 to User B's information terminal 22, through the internet or a network (Step S403). In the example shown in FIG. 2, User A is sending 4 personal information sets along with the identification tag of User A. Each set contains the names in 4 types of notations such as Kanji, Katakana, English and Hangul, and these names are tagged with a respective display attribute. The information sent from the terminal 21 of User A is received by a communication device 101 of User B (a receiver and sender device). This received information is sent to the external memory unit 24 through a bus 108, and it is stored in the memory after tagging with the identification tag of A (Step S404). Moreover, the identification tag of A is a numeric value or a string that is used by the application software 112 to uniquely identify A whose name information is disclosed. As shown in the example in FIG. 2, four types of characters namely; [symbol] [symbol] “Ichiro Suzuki” and

[symbol]

that are sent from the terminal of User A, are tagged with respective display attributes. Further, all are tagged with the unique identification tag of A and then stored in the memory unit 24 of User B's terminal. Here, for general description, User A has taken country name, notation system etc. as an example of attribute information correlated with the information of each name. However, any information can be taken as an example of an attribute of these names. For example, User A is the person sending name information and the preference order to be displayed can be considered as attribute information. “Default attribute” showing the name information to be displayed on information terminal UGI 121 of User B when the attribute information correlated with the name information sent by User A in the third step to the information terminal of User B is not available in the attribute information selected by User B in the second step mentioned above, can also be the attribute information.

In the fourth step, if by using Mouse 106 etc. User B instructs the application software 112, which manages personal information such as an address list mentioned previously, to display the name of User A (S405), this application software 112 searches whether there exists any display attribute that is already selected in the second step through the operations of window for display attributes selection, in the display attributes of names, which are sent from User A in the third step and which are tagged with the identification tag of A registered in the external memory unit 24 (Step S406). If it exists, it displays the name information having attribute that is selected in second step, in window 122 used to display or enter the name (Step S410). If it does not exist, the application software 112 does not display the information in window 122 (Step S408). However, when the translation program 109 exists in the main memory of the information terminal of B, by using this program the name of A is translated (Step S409) into the information of notation that is already selected in the second step, and then this translated name is displayed in window 122 (Step S410). In the example shown in FIG. 3, since in the first step, “KOREA” indicating the Korean language is selected in window 123a for display attribute selection, and

[symbol]

indicating Hangul (Korean character) is selected in window 123b for display attribute selection, the Hangul notation of [symbol] i.e. [symbol]
is displayed in window 122 used to display or enter the name.

In the fifth step, according to the attribute already selected in window 123 by B in the second step, the name display of A displayed in window 122 used to display or enter the name in the fourth step is changed to display attributes other than that of the name correlated with A's identification tag stored in the external memory unit in the third step, by operating window 123 with the help of mouse 106 etc. (Step S412). The notation desired by User B from the display attributes disclosed by other users including User A, can be displayed in window 122. For example, in the second step as shown in FIG. 3, to display the English notation “Ichiro Suzuki” of

[symbol]

when “KOREA” indicating Korean language is selected in window 123a, 1) Click the button 51 for alternative display (shown in FIG. 5) by using Mouse 106 etc. Option 52 will be displayed. 2) Select “ENGLAND” so that the English notation “Ichiro Suzuki” of [symbol]
stored in the external memory unit 24 in the third step will be displayed in window 122 shown in FIG. 3.

As a result of this embodiment 1, in the application software of an address list or phone book which uses this invention, the recipient of disclosed information can select the display attribute in advance from the various methods of displaying the names disclosed by the disclosing party. As a result, the recipient of disclosed information can easily access or use the name of a disclosing party by using a simple and intuitive GUI. Generally, the disclosed notations need not be always displayed on the GUI for the recipient of disclosed information. For example, when a British person discloses private information to a Korean person, English and Hangul notation need not be always included in the Name field on the GUI of the Korean person's address list or phone book. In such a case, as a user of the application software of an address list, phone book etc. which uses this invention, the Korean recipient of disclosed information can specify the Hangul notation in advance in the second step of embodiment 1. Thus the address list or phone book can be made more user-friendly by using the simple and intuitive GUI.

In this embodiment, the name of a discloser has been used as an example of the information which the discloser sent to and displayed on a recipient's terminal but any information can be such information.

In this embodiment 1, attributes of the information set sent from user A's terminal to user B's terminal do not include the attribute which was selected by user B in step S402 in advance. In this case, similar to Step S408, window 122 used to display or enter the name on GUI 121 can remain empty, however, any name from the names of User A, which are correlated with each attribute information and which are stored in the memory unit of the information terminal of User B in Step S404, can also be displayed in window 122. In the information terminal of User B, there are 3 methods mentioned below to select the name to be displayed in window 122 from the names of User A stored in Step S404.
(1) When it is displayed on GUI 121 that the name information having the attribute selected in advance in the second step is not sent from the information terminal of User A in the fourth step, User B can select the names that are sent from the information terminal of User A in the fourth step, and are displayed as options so that they can be selected on the GUI.
(2) Any name with the attribute that is determined in advance by the application software 112 on the information terminal of User B can be displayed.
(3) In the third step, in addition to the attribute information, User A correlates the display precedence in the information terminal of User B, who is the recipient, to each name information to be sent to the terminal of User B through A's information terminal, and when the attribute information selected by User B in the second step does not exist within the information associated with the name information sent from the information terminal of User A, the name of A is displayed in window 122 on the basis of the display precedence sent by A to B.

Moreover, in the example in FIG. 3, even though there is only single name information displayed in window 122, multiple name information can also be displayed simultaneously, and along with each name information, the attribute information correlated by A can also be displayed by correlating it on the GUI of the information terminal of User B.

Moreover, in embodiment 1, User B selects the display attribute in advance in the second step (Step S402), and the name correlated with that display attribute among the names disclosed to User B from other users including User A, is displayed on GUI (Step S411). It is also possible to control the display attribute in the component on the GUI that displays or controls the display attribute as shown in window 123 for display attribute selection in the example in FIG. 3, according to the display attribute specified in the second step by using exactly the same method.

Moreover, in the third step of embodiment 1, the information terminal 22 of User B obtains the information when User A, who is the disclosing party, sends the name information correlated with attribute information, from its information terminal 21 to the information terminal 22 of User B. However, the name information correlated with the attribute information can be stored in a third server and user B can request this third server for the name information correlated with the attribute information of User A. When the information terminal 22 of User B receives this information from terminal 21 directly or through a third server it is stored in the memory unit of the information terminal 22 of User B by tagging with the identification tag of User A.

### Embodiment 2

### Precedence is Set in Advance for Attributes

In embodiment 2, with the help of application software in the present invention, User B, who is the recipient of disclosed information, can use a flexible and simple GUI by selecting the display attribute of information of disclosing party A, to be displayed, before the disclosure by A. However, under present circumstances, it is not always necessary for the disclosing party A to disclose in the notations according to the language and attributes desired by recipient B. For example, as shown in FIG. 2, A discloses the name to B in 4 languages such as Japanese: Kanji, Japanese: Katakana, English and Korean: Hangul; and according to the attribute notations. Consequently, in the second step of embodiment 1 mentioned above, although B selects the setting to display in Japanese Hiragana notation in the address list or phone book which uses this invention, since the Hiragana notations are not registered in the external memory unit 24 shown in FIG. 3 in the third step of embodiment 1 mentioned above, the Hiragana notation

[symbol]

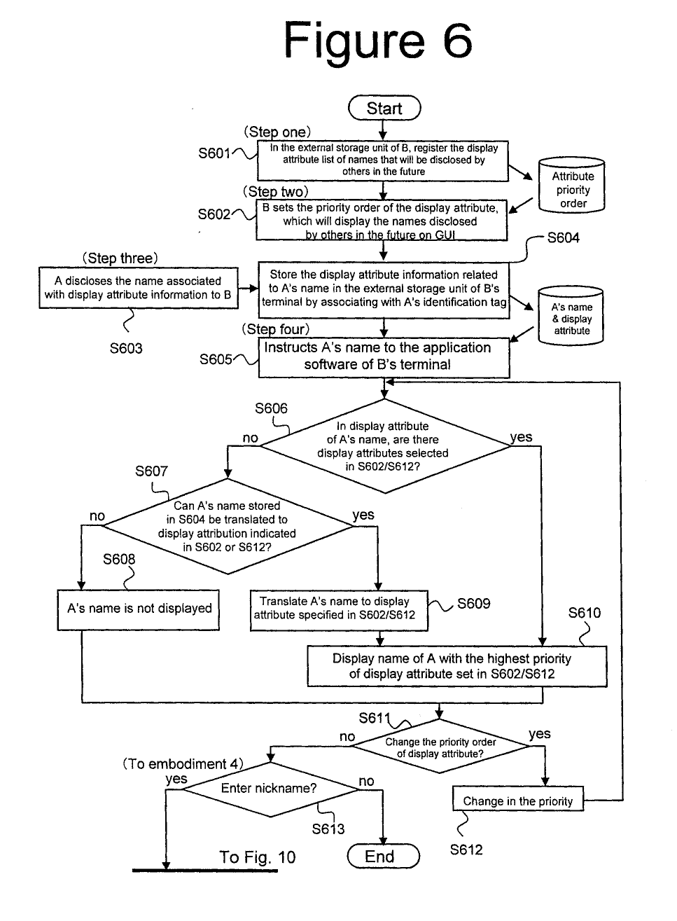

cannot be displayed in window 122 used to display the name. Moreover, in another example, when an American, who is the user of the application software of an address list or phone book of this invention, is the disclosing party, and when they have the notation of Indian Gujarati language stored in memory unit 23 on their own information terminal, there is little possibility of disclosing the information to other users. However, an Indian person who knows this American may desire the notations in Gujarati language in the application software of their address list or phone book. Embodiment 2 is a method for resolving this problem. Further, the description of embodiment 2 given below is shown in the form of a flowchart in FIG. 6.

In first step of Embodiment 2, a display attribute list with the names to be disclosed in future by other users is registered in the external memory unit 24 exactly the same as in the first step of embodiment 1 mentioned above (S601). For example, the application software 112 that manages personal information such as an address list which uses this invention, registers all country names that are likely to be used and the names of various notation systems in these countries etc. in the external memory unit 24.

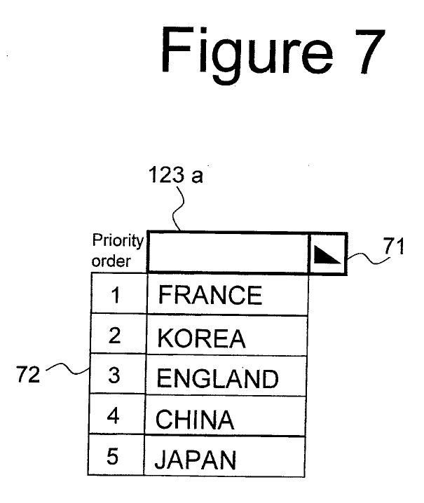

In this invention, GUI121 consists of window 122 used to display or enter the name and window 123 for the precedence setting of display attribute. In the second step, similar to the second step in embodiment 1 mentioned above, User B uses input devices such as keyboard 105 or mouse 106 to operate the window for precedence setting of a display attribute. From the attribute display list registered in external memory unit 24 in the first step, User B can select the language and notation attributes with which the name information disclosed by other users including A, is to be displayed in window 122 (S602). This precedence can also be directly input in window 123 for precedence setting of a display attribute and in another window for precedence settings of a display attribute created by application software 112. In the example shown in FIG. 7, window for precedence settings of display attributes, which is located on GUI121, has button 71 for precedence input. If User B clicks this button with the help of mouse 106, the precedence input of display attributes registered in the external memory unit in the first step of embodiment 2, is displayed on display unit 72. In the example shown in FIG. 7, since User B inputs in the sequence of “FRANCE”, “KOREA”, “ENGLAND”, “CHINA”, JAPAN”, the name information displayed by other users is displayed in window 122 in the sequence of “French”, “Korean”, “English”, “Chinese” and “Japanese”.

In the third step, similar to the third step in embodiment 1, User A discloses the information to User B by sending it from A's terminal 21 to the information terminal 22 of User B through the internet or a network (S603). In the example in FIG. 2, User A sends the names in four types of notations; Kanji, Katakana, English and Hangul to the terminal 22 of User B by correlating each display attribute of these names. The information, sent from terminal 21 of User A, is received by communication device 101 of User B's terminal and it is sent to external memory unit 24 through bus 108. Further, it is stored there after tagging it with the identification tag of User A (S604). In the example given in FIG. 2, four types of characters [symbol] [symbol] “Ichiro Suzuki” and

[symbol]

are stored after correlating with the display attribute of respective character information.

In the fourth step, when User B instructs the application software 112, which manages personal information such as an address list etc. mentioned previously, to display the name of User A (S605), this application software searches whether there exists any information of attributes, which are sent from User A in the third step of embodiment 2 and which are already set through the operations of precedence setting window 123 of attributes in the second step of this embodiment 2, in the display attributes of the name tagged with the identification tag of A registered in external memory unit 24 (S606). If there is only one attribute, the name correlated with that display attribute; and if there are more than two attributes, the name correlated with the display attribute having the highest precedence that is input in the second step of this embodiment, is displayed in window 122 used to display or enter the name (S610). For example, in the example shown in FIG. 7, since the precedence order is input in the order of French, Korean, English, Chinese and Japanese; the name, Ichiro Suzuki is displayed in window 122, as shown in FIG. 3, in Korean language having the highest precedence among the names tagged with the identification tag of User A registered in the external memory unit of the information terminal of User B. If the name, which is correlated with the display attribute for which the precedence order is set in the second step above, does not exist in external memory unit 24, then either the window 122 will remain empty (S608), or the name is translated into the notation of attributes having the highest precedence that is already selected in the second step by the translation program called from the main memory of B's information terminal (S609), and then the translated name is displayed in window 122 (S610). Even though this translation is performed by the translation program 109 available in the main memory unit on the information terminal 22 of B, it can also be performed by the translation program available in other information terminals connected to the network or the internet.

Moreover, in the state where the name is displayed in window 122 by using the method in this embodiment 2, it is possible to change the precedence order (S612) from window 123 used for precedence display and input in the display attribute of a name tagged with the identification tag of A. The precedence can be changed either by using precedence setting window 123 of direct attributes, or by using a separate precedence order input window that is created by application software 112. Moreover, in the state where the name is displayed by using the method given in embodiment 2, the attribute to be displayed can be selected directly similar to the method mentioned in the second step of embodiment 1, irrespective of the precedence order.

In embodiment 1, there is the problem where no name is displayed on name window 122 when no name with an attribute which was previously selected by user B through window 123 is disclosed by user A. However, this problem is resolved in embodiment 2.

Moreover, as an example of this embodiment 2, the name is used as information, which is disclosed by the disclosing party, and is displayed on the GUI by the recipient of the disclosed information, however, any other information can also be used instead.

In the example in this embodiment 2 mentioned above, among the display attributes of the names of A that is sent from the information terminal of A to B, it is not necessary to include the display attribute, which displays the name that is selected by User B in advance in the second step (Step S602) and that is disclosed to User B from other users including User A on a GUI, in the fourth step mentioned above. In the case of no precedence order being set in step 602, similar to Step S608, window 122 used to display or enter the name on GUI 121 can remain empty, however, any name from the names of User A, which are correlated with each attribute information and which are stored in the memory unit of the information terminal of User B in Step S604, can also be displayed in window 122. To do so, in the information terminal of User B, there are 3 methods mentioned below to select the name to be displayed in window 122 from the names of User A stored in Step S604.
(1) When it is displayed on GUI 121 that the name information having the attribute selected in advance in the second step is not sent from the information terminal of User A in the fourth step, User B can select the names that are sent from the information terminal of User A in the fourth step, and are displayed as options so that they can be selected by using mouse 106 on GUI.
(2) Any name that is determined in advance by the application software 112 on the information terminal of User B can be displayed.
(3) In the third step, in addition to the attribute information, User A correlates the display precedence in the information terminal of User B, who is the recipient, to each name information to be sent to the terminal of User B through its information terminal, and when the attribute information selected by User B in the second step does not exist within the information correlated with the name information sent from the information terminal of User A, the name of A is displayed in window 122 on the basis of the display precedence sent by A to B.

Moreover, in the example in FIG. 3, even though there is only single name information displayed in window 122, multiple name information can also be displayed simultaneously, and along with each name information, the attribute information correlated by A can also be displayed by associating it, on the GUI of the information terminal of User B.

Moreover, in embodiment 2, User B selects the display attribute in advance in the second step (Step S602), and the name correlated with that display attribute among the names disclosed to User B from other users including User A, is displayed on the GUI (Step S611). It is also possible to control the display attribute in the component on the GUI that displays or controls the display attribute as shown in window 123 for display attribute selection in the example in FIG. 3, according to the display attribute specified in the second step by using exactly the same method.

Moreover, in the third step of embodiment 2, the information terminal 22 of User B obtains the information when User A, who is the disclosing party, sends the name information correlated with attribute information, from its information terminal 21 to the information terminal 22 of User B. The name information associated with the attribute information can be stored in a third server correlated with the attribute information of User A. User B makes a request to this third server for the name information correlated with the attribute information of User A through information terminal 22, and this server sends this information to the information terminal of User B. Thus, when the information terminal 22 of User B receives this information, it is stored in the memory unit of the information terminal 22 of User B by tagging with the identification tag of User A.

### Embodiment 3

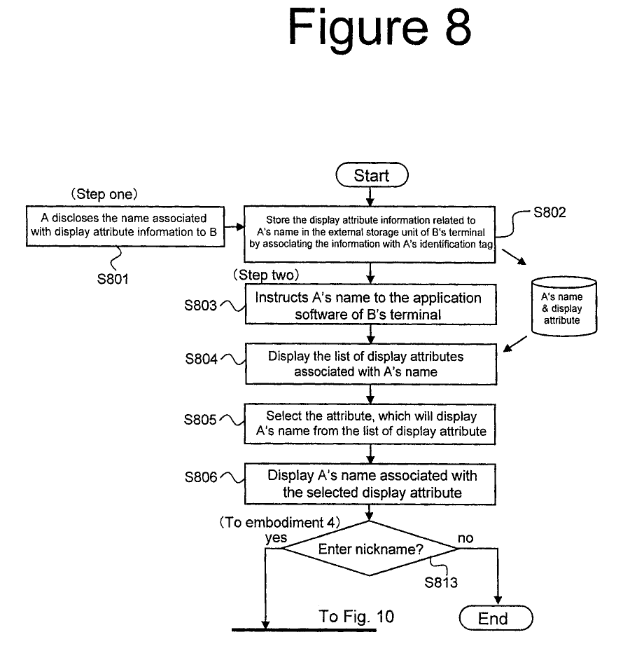

In embodiment 1 and 2 mentioned above, the display attributes, which can display the name information disclosed by other users, are already registered in external memory unit 24 of the information terminal of B, who is the recipient of the disclosed information before disclosure. However, sometimes the disclosing party may actually send the attributes information which has not been registered in this step. In the case of information such as Name, which is explained with an example in embodiment 1 and 2, if all languages across the world and the notations used in each language are registered, this type of problem is not likely to occur. However, in the third step of embodiment 1 or 2, when User A adds information regarding a URL as to what type of information that URL relates to, as attribute information in the particular URL of the internet, and when the name information is disclosed to User B, then there is little possibility of the attribute information, required by the recipient of disclosed information from the disclosing party, being registered in the external memory unit 24 of its information terminal. Therefore, the information desired by the recipient of disclosed information may not be displayed in the window for information display. This problem can be resolved by using the method mentioned in embodiment 3. The flowchart for embodiment 3 is given in FIG. 8.

In the first step of this embodiment 3, similar to the third step in embodiment 1 and 2 mentioned above, User A discloses the information to User B by sending it from its terminal 21 to the information terminal 22 of User B through an inter-network or network (S801). In the example in FIG. 2, User A sends the names in four types of notations; Kanji, Katakana, English and Hangul to the terminal 22 of User B by correlating each display attribute of these names. The information, sent from terminal 21 of User A, is received by communication device 101 of User B's terminal and it is sent to external memory unit 24 through bus 108. Further, it is stored there after tagging with the identification tag of User A (S802). In the example given in FIG. 2, the four types of characters [symbol] [symbol] “Ichiro Suzuki” and

[symbol]

sent from the terminal of User A are stored in the memory unit 24 of the terminal of User B, by tagging with the identification tag for User A along with respective display attributes.

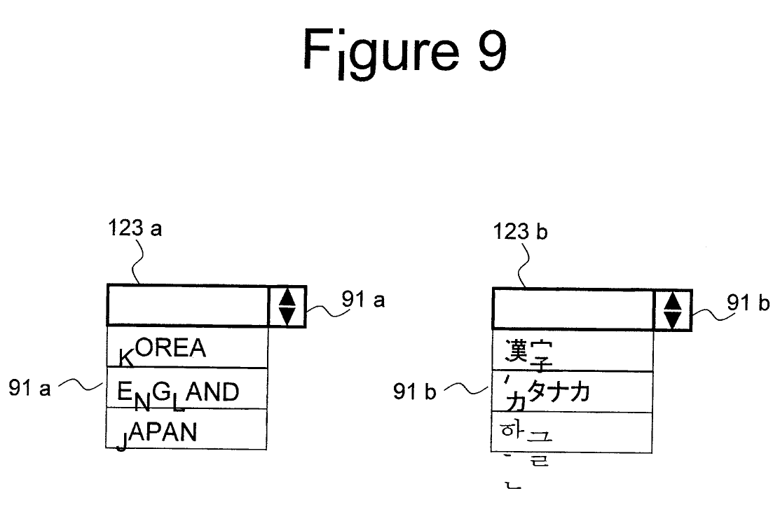

In the second step, B instructs the application software 112, which manages personal information such as an address list etc., to display the name of A (S803), and this application software reads from the main memory unit 104, the list of display attributes of the name tagged with the identification tag of A from the information which is sent from terminal 21 of User A and which is stored in the external memory unit in the first step of embodiment 3 mentioned above. According to the methods of this invention, this GUI consists of window 122 used for display or input of a name and window 123 for display attribute selection. There can be one or more windows. Moreover, B displays the list of display attributes of a name tagged with the identification tag of A on GUI 121, which is read from the main memory unit in this step by operating the window 123 for display attributes selection (S804). In the example in FIG. 9, window 123, which is located on the GUI 121, has the language option display button 91a and notation attributes display button 91b. When User A clicks the language option display button 91a with the help of mouse 106, “KOREA”, “ENGLAND” and “JAPAN” are displayed as a list of languages correlated with the name disclosed by User A as mentioned in the first step above. Similarly, when User B clicks the notation attributes display button 91b by using the mouse 106, “Kanji”, “Katakana” and

[symbol]

are displayed as a list of display attributes of the name tagged with the identification tag of User A as mentioned in the first step above. User B can specify the display attribute of the name to be displayed on window 112 for displaying a name in FIG. 3 (S806) after selecting the option shown in FIG. 9 by using mouse 106 or keyboard 105 (S805). For example, in the example in FIG. 3, since “KOREA” is selected in the language selection window and [symbol]
indicating Korean characters is selected in the notation selection window, then Korean notation [symbol]
indicating Ichiro Suzuki is displayed on window 122 used to display or enter the name.

As a result of embodiment 3, it is possible to control the language and notation of the name information, which have not been registered by the recipient of disclosed information before disclosure and which is displayed on a GUI of the recipient of disclosed information, on the basis of information of language or notation attributes correlated with the information disclosed by the disclosing party to the recipient of the disclosed information. Moreover, this embodiment 3 can be used in combination with embodiment 1 or 2 mentioned above.

### Embodiment 4

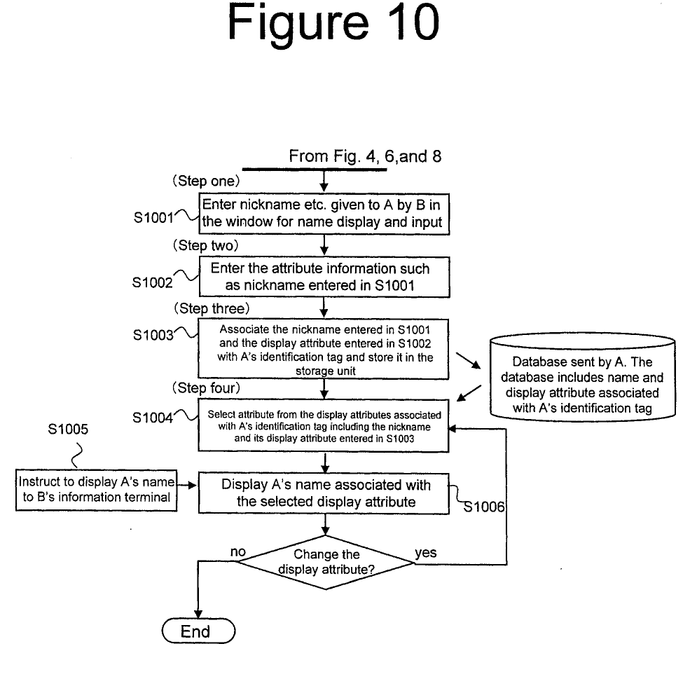

In embodiment 1, 2 and 3 mentioned above, in the state where language or notation attributes are correlated, A, who is the disclosing party, discloses various notations of their own name to B, who is the recipient of the disclosed information. B, who is the recipient of the disclosed information, controls the names of A displayed on the GUI of the information terminal of B, on the basis of the language or attributes information correlated by A. However generally, the recipient of disclosed information needs to manage the information by assigning the names to it regardless of the information disclosed by the disclosing party. For example, B, who is the recipient of the disclosed information, may call A, who is the disclosing party, by a nickname. However, A, the same disclosing party, may not be called by the same nickname by other users. In such a case, since the nickname given to A by B is only identifying A by B themselves, B should be able to overwrite the name of A or attributes information correlated with this name, regardless of the name notations disclosed by A in order to identify A in the application software of address list of this information terminal. This problem can be solved by the methods in this embodiment 4. A flow chart for embodiment 4 is given in FIG. 10.

By using the methods given in this embodiment 4, the fourth step in embodiment 1 and embodiment 2 mentioned above, or the second step in embodiment 3 are completed, and the subsequent processes are started in the state where the name of A is displayed in window 122 (S413 in FIG. 4, S613 in FIG. 6 and S813 in FIG. 8).

Referring to FIG. 3, in the initial stage of the first step in embodiment 4, User B uses mouse 106 of terminal 22 to select window 122 and can enter any character string in window 122. Further, User B uses keyboard 106 to enter any character string in window 122 (S1002). For example, here, a nickname given to A by B is entered and not the name disclosed by A.

Moreover, in the second step, User B uses the mouse to select window 123 for attribute selection and can enter any character string in window 123. Similarly, B uses the keyboard to enter attribute information related to a nickname that is entered in the first step mentioned above (S1002). Here, for example; various information such as language, notation system or personally defined nickname etc. is entered.

Further, in the third step, information such as the nickname of A etc. entered by B in the first and second steps mentioned above is stored in the external memory unit tagged with A's identification tag (S1003). Here, in the third step of embodiment 1 (S404), the third step of embodiment 2 (S604) or the second step of embodiment 3 (S802); the information such as nickname and its correlated display attributes stored in the third step of embodiment 4 is added to the database containing multiple names of A and respective display attributes stored in the external memory unit tagged with A's identification tag and is stored in an external memory unit.

Further in the fourth step, again by referring to FIG. 3, display attributes in the database mentioned above displayed in window 123 for attribute selection on GUI121 are selected by using mouse (S 1004). The display attribute to be selected here, in the third step of embodiment 1 (S404), the third step of embodiment 2 (S604) or the second step of embodiment 3 (S802) may be the display attribute correlated with the name stored in the external memory unit tagged with A's identification tag, or attribute information correlated with the nickname entered in the second step of embodiment 4.

Further, when B's information terminal is instructed to display A's name (S1005), a name that includes a nickname, which is entered in this embodiment and which is correlated with that display attribute, is displayed in window 122 used to display or enter the name (S1006).

What is claimed is:

1. An information terminal comprising:
a receiver, said receiver receiving an identification tag, said identification tag having a plurality of sets of information including first information and attribute information which is correlated with said first information;
a storage device, said storage device storing said identification tag and said plurality of information sets; and
a display, said display displaying said first information, said first information being correlated with said attribute information based on said attribute information which is selected by a user from said plurality of sets of information.

2. The information terminal according to claim 1 wherein said first information is personal information and wherein said attribute information is used to control displaying said personal information.

3. The information terminal according to claim 2 wherein said storage device stores said attribute information selected by said user, and said display displays said personal information based on said attribute information.

4. The information terminal according to claim 1 wherein said attribute information has an order of precedence among said attribute information within said plurality of sets of information, and said display displays said first information which is correlated with said attribute information having the highest order of precedence.

5. The information terminal according to claim 4 wherein said storage device stores said order of precedence and said display displays said personal information based on said order of precedence.

6. The information terminal according to claim 1 wherein said first information is input by said user.

7. The information terminal according to claim 2 wherein said personal information is input by said user.

8. The information terminal according to claim 1 wherein said attribute information includes display attributes and wherein said display displays at least one part of said attribute information based on said display attributes.

9. The information terminal according to claim 2 wherein said attribute information includes display attributes and wherein said display displays at least one part of said attribute information based on said display attributes.

10. The information terminal according to claim 8 wherein said display displays said information based on said display attributes, said display attributes being selected by said user.

11. A server comprising:
a microprocessor, said microprocessor creating a plurality of sets of information including first information and attribute information, said attribute information is used to control displaying said first information, said microprocessor assembling said plurality of sets of information and creating an identification tag which includes assembled said plurality of sets of information, said identification tag and said plurality of sets of information being sent to an information terminal.

12. The server according to claim 11 wherein said first information is personal information and wherein said attribute information is used to control displaying said personal information.

13. The server according to claim 12 wherein said microprocessor attaches an order of precedence to each of said attribute information among said plurality of sets of information.

14. An information processing method comprising:
creating a plurality of sets of information including first information and attribute information by a microprocessor, said attribute information is used to control displaying said first information;
assembling said plurality of sets of information and creating an identification tag which includes assembled said plurality of sets of information by said microprocessor, said identification tag and said plurality of sets of information being sent to an information terminal;
receiving said identification tag by an information terminal, said identification tag having said plurality of sets of information including said first information and said attribute information which is correlated with said first information;
storing said identification tag and said plurality of information sets in said information terminal; and
displaying said first information on said information terminal, said first information being correlated with said attribute information based on said attribute information which is selected by a user from said plurality of sets of information.

15. The information processing method according to claim 14 wherein said first information is personal information and wherein said attribute information is used to control displaying said personal information.

16. The information processing method according to claim 15 wherein said storage device stores said attribute information selected by said user, and said display displays said personal information based on said attribute information.

17. The information processing method according to claim 14 wherein said attribute information has an order of precedence among said attribute information within said plurality of sets of information, and said display displays said first information which is correlated with said attribute information having the highest order of precedence.

18. The information processing method according to claim 17 wherein said storage device stores said order of precedence and said display displays said personal information based on said order of precedence.

19. The information processing method according to claim 14 wherein said first information is input by said user.
